(19) United States
(12) Patent Application Publication
(10) Pub. No.: US 2023/0114862 A1
(43) Pub. Date: Apr. 13, 2023

(54) ROTATING MECHANISM AND HOUSING CASE

(71) Applicant: GUANGDONG OPPO MOBILE TELECOMMUNICATIONS CORP., LTD., Dongguan (CN)

(72) Inventors: Zhaoqiu CAI, Dongguan (CN); Huacan CUI, Dongguan (CN); Li ZHANG, Dongguan (CN)

(21) Appl. No.: 18/066,587

(22) Filed: Dec. 15, 2022

Related U.S. Application Data
(63) Continuation of application No. PCT/CN2021/095439, filed on May 24, 2021.

(30) Foreign Application Priority Data
Jun. 16, 2020 (CN) 202010550871.6
Jun. 16, 2020 (CN) 202021113797.3

(51) Int. Cl. H04R 1/10

(52) U.S. Cl. CPC H04R 1/1025; H02J 7/0042

(57) ABSTRACT

A rotating mechanism and a housing case are provided. The rotating mechanism includes a connection panel, a mounting base, and a rotating shaft. The connection panel has a first position and a second position. The mounting base includes a base body and protruding portions extending out of either side of the base body. The base body has a second notch. The second notch is arranged between the two protruding portions. Each protruding portion forms an accommodation slot opened toward the outer side of the base body. When the connection panel is in the first position, a portion of the connection panel is in the inner side of the base body, and when the connection panel is in the second notch, the portion of the connecting panel is arranged in the notch and closes the notch.

### CROSS REFERENCE OF RELATED APPLICATIONS

The present disclosure is a continuation of International Patent Application No. PCT/CN2021/095439, filed on May 24, 2021, which claims priority to Chinese Patent Application No. 202010550871.6 filed on Jun. 16, 2020 and Chinese patent application No. 202021113797.3 filed on Jun. 16, 2020. The entire disclosures of the above-identified applications are incorporated herein by reference.

### TECHNICAL FIELD

The present disclosure relates to the technology field of earphone storage, and in particular to a rotating mechanism and a housing case.

### BACKGROUND

A current earphone charging box includes a case body and a case cover pivotally connected to the case body. The case body forms a holding space with a top opening, and the case cover is configured to close the case body. The case cover pivots relative to the case body to be switched between an open position and a closed position. The holding space of the case usually requires to accommodate not only earphones but also other structures for charging the earphones, therefore it is important to make a structure of earphone charging box compact.

### SUMMARY OF THE DISCLOSURE

According to the above, in one aspect, a rotating mechanism is provided in some embodiments of the present disclosure. The rotating mechanism includes: a connecting panel, a mounting base, and a rotating shaft.

The connecting panel has a first position and a second position.

The mounting base includes a base body and two protruding portions, one of the two protruding portions extends along one of both sides of the base body, and the other of the two protruding portions extends along the other of both sides of the base body. The base body defines a notch, the notch is defined between the two protruding portions, each of the protruding portions define an accommodation slot, and the accommodation slot is opened toward an outer side of the base body; when the connecting panel is arranged in the first position, a portion of the connecting panel is arranged on an inner side of the base body; and when the connecting panel is arranged in the second position, the portion of the connecting panel is arranged in the notch and closes the notch.

The rotating shaft extends through the connecting panel and the base body and further extending into the accommodation slot to enable the connecting panel to be switched between the first position and the second position.

In another aspect, a housing case is provided in some embodiments of the present disclosure. The housing case includes a case cover, a case body, and a rotating shaft.

The case cover includes a cover shell and a connecting panel connected to the cover shell.

The case body includes a shell body and a mounting base. The shell body defines a holding space having a top opening and a first notch defined in a side wall of the shell body, and the holding space is fluidly connected to the first notch; the mounting base comprises a base body and two protruding portions, one of the two protruding portions extends along one of both sides of the base body, and the other of the two protruding portions extends along the other of both sides of the base body; the base body defines a second notch, each of the protruding portions defines an accommodation slot, the mounting base is mounted in the first notch, the protruding portions are arranged in the holding space, the accommodation slot is opened towards the side wall of the shell body, and the accommodation slot and the side wall of the shell body cooperatively define a first shaft hole.

The rotating shaft extends through the connecting panel and the base body and further extends into the first shaft hole to enable the cover shell to be switched between an open position and a closed position at which the shell body is closed; when the cover shell is in the closed position, a portion of the connecting panel is arranged in the second notch to close the second notch, and a portion of the base body and the portion of the connecting panel cooperatively close the first notch.

In a further aspect, a housing case may be provided. The housing case includes a case, defining a first notch in a side wall of the case; a cover, connected to the case and having an open position at which the case is opened and a closed position at which the case is closed; a mounting base, mounted in the first notch, and comprising: a supporting bar; and two connecting bars, wherein one of the connecting bars is connected to one of the two opposite ends of the supporting bar, the other of the connecting bars is connected to the other of two opposite ends of the supporting bar, and the supporting bar and the two connecting bars cooperatively define a second notch; a connecting panel, connected to the cover and comprising: an intermediate portion; and an outer-edge portion, arranged at a periphery of the intermediate portion; and a rotating shaft, extending through the connecting panel and connected to the case to enable the cover to be switched between the open position and the closed position. When the cover is in the closed position, the outer-edge portion, the supporting bar, and the two connecting bars are enclosed together to define a ring structure, and the intermediate portion is arranged in the ring structure, such that the supporting bar, the two connecting bars, the outer-edge portion and the intermediate portion cooperatively close the first notch, while the outer-edge portion and the intermediate portion cooperatively close the second notch.

### BRIEF DESCRIPTION OF THE DRAWINGS

FIG. 1 is a structural schematic view of one state of a housing case provided in some embodiments of the present disclosure, wherein a case cover is in a closed position.

FIG. 2 is a structural schematic view from another viewpoint of the housing case according to FIG. 1.

FIG. 3 is a structural schematic view of another state of the housing case according to FIG. 1, wherein the case cover is in an open position.

FIG. 4 is a structural schematic view of the housing case according to FIG. 3 without a storage cover.

FIG. 5 is an explosive structural schematic view of the housing case according to FIG. 3.

FIG. 6 is a structural schematic view of a case cover provided in some embodiments of the present disclosure.

FIG. 7 is a structural schematic view of a case body provided in some embodiments of the present disclosure.

FIG. 8 is a structural assembled schematic view of a connecting panel, an mounting base, a rotating shaft, and an elastic member provided in some embodiments of the present disclosure.

FIG. 9 is a structural schematic view from another viewpoint of the structure according to FIG. 8.

FIG. 10 is a structural schematic view from another viewpoint of the structure according to FIG. 8.

FIG. 11 an explosive structural schematic view of the structure according to FIG. 8.

FIG. 12 is a structural schematic view of a mounting base provided in some embodiments of the present disclosure.

FIG. 13 is a structural schematic view from another viewpoint of the mounting base according to FIG. 12.

FIG. 14 is a structural schematic view from another viewpoint of the mounting base according to FIG. 12.

FIG. 15 is a structural schematic view of a connecting panel provided in some embodiments of the present disclosure.

FIG. 16 is a structural schematic view from another viewpoint of the connecting panel according to FIG. 15.

FIG. 17 is a cross-sectional schematic view of the housing case according to FIG. 1.

FIG. 18 is a structural schematic view of another state of the structure according to FIG. 17, wherein the case cover is in an open position.

FIG. 19 is a schematic view illustrating a mechanics principle of the housing case in some embodiments of the present disclosure, wherein a case cover is in an open position.

FIG. 20 is a schematic view illustrating a mechanics principle of another state of the structure according to FIG. 19, wherein the case cover is in a closed position.

FIG. 21 is a structural schematic view of an elastic member provided in some embodiments of the present disclosure.

### DETAILED DESCRIPTION

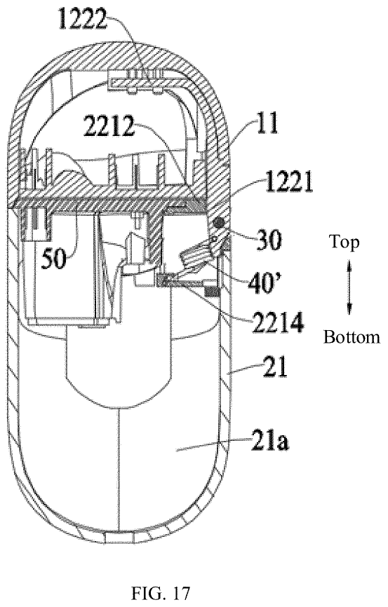

It should be noted that some embodiments and some technical features in the embodiments of the present disclosure may be combined with each other without conflict. In the embodiments of the present disclosure, “mm” refers to the international unit millimeter. The “top”, “bottom”, orientation or position relationship is based on the orientation or position relationship shown in the attached FIG. 17. In some embodiments, the top in FIG. 17 is “top” and the bottom is “bottom”. It should be understood that these orientation terms are intended only to facilitate and simplify the description of the present disclosure, and are not intended to indicate or imply that the device or element referred to must have a particular orientation, be constructed and operate in a particular orientation, and therefore are not to be considered as a limitation of the present disclosure. The detailed description in the embodiments is to be understood as an explanatory statement of the purpose of the present disclosure and is not to be considered an undue limitation of the present disclosure.

Some embodiments of the present disclosure expect to provide a rotating mechanism and a housing case, featuring a compact structure. To achieve the above beneficial effect of the feature, a technical solution in the embodiments of the present disclosure is realized as follows.

Some embodiments of the present disclosure provide, in one aspect, a rotating mechanism including a connecting panel, a mounting base, and a rotating shaft.

The connecting panel has a first position and a second position.

The mounting base includes a base body and two protruding portions, one of the two protruding portions extends along one of both sides of the base body, and the other of the two protruding portions extends along the other of both sides of the base body. The base body defines a notch, the notch is defined between the two protruding portions, each of the protruding portions define an accommodation slot, and the accommodation slot is opened toward an outer side of the base body; when the connecting panel is arranged in the first position, a portion of the connecting panel is arranged on an inner side of the base body; and when the connecting panel is arranged in the second position, the portion of the connecting panel is arranged in the notch and closes the notch. Herein, the notch defined in the base body may also be referred as the second notch 221a in the following.

The rotating shaft extends through the connecting panel and the base body and further extending into the accommodation slot to enable the connecting panel to be switched between the first position and the second position.

In some embodiments, the base body includes a supporting bar and two connecting bars, the supporting bar extends in an axial direction of the rotating shaft, one of the connecting bars is connected to one of the two opposite ends of the supporting bar, and the other of the connecting bars is connected to the other of two opposite ends of the supporting bar. The supporting bar and the connecting bars cooperatively define the second notch, each of the protruding portions is connected to a corresponding one of the connecting bars, and the rotating shaft extends through the connecting bars and further extends into the accommodation slot.

The connecting panel comprises a first panel body and a second panel body, the first panel body comprises an intermediate portion and an outer-edge portion, the outer-edge portion is arranged at a periphery of the intermediate portion, and the outer-edge portion defines an avoidance slot on each of both opposite sides along the axial direction of the rotating shaft; when the connecting panel is arranged in the second position, a portion of each of the connecting bars is arranged in the avoidance slot, the outer-edge portion, the supporting bar, and the two connecting bars are enclosed together to define a ring structure, and the intermediate portion is arranged in the ring structure; the second panel body is connected to an inner end face of the first panel body, the second panel body defines a second shaft hole arranged along the axial direction of the rotating shaft, and the rotating shaft penetrates into the second shaft hole.

In another aspect, a housing case is provided in some embodiments of the present disclosure. The housing case includes a case cover, a case body, and a rotating shaft.

In some embodiments, the connecting panel includes a first panel body and a second panel body.

The first panel body defines an avoidance slot on each of both opposite sides of the first panel body along the axial direction of the rotating shaft. When the cover shell is in the closed position, a portion of each of the connecting bars is arranged in the avoidance slot, and the portion of each of the connecting bars, a portion of the supporting bar, and the first panel body cooperatively enclose the first notch.

The second panel body includes a connecting portion and an extension portion extending from the connecting portion toward the case cover. The connecting portion is connected to a side of the first panel body near the holding space. The connecting portion defines a second shaft hole disposed in the axial direction of the rotating shaft, and the rotating shaft penetrates into the second shaft hole.

In some embodiments, the first panel body includes an intermediate portion and an outer-edge portion. The outer-edge portion is arranged at a periphery of the intermediate portion, and the avoidance slot is defined in the outer-edge portion; the outer-edge portion, the supporting bar, and the connecting bars are enclosed together to form a ring structure, and the intermediate portion is arranged in the ring structure.

In some embodiments, the first panel body defines a groove on an end face facing toward the holding space, the groove extends in the axial direction of the rotating shaft, and a portion of the rotating shaft is arranged in the groove.

In some embodiments, the second panel body includes a tab extending from the connecting portion toward the base body, the base body comprises a top panel connected to a top of each of the connecting bars, and the supporting bar and the top panel cooperatively define a rotating space. The rotating shaft is arranged between the top panel and the supporting bar along a height direction of the base body, the tab is capable of rotating around an axis of the rotating shaft within the rotating space, the tab is capable of abutting against the top panel to limit the open position of the cover shell, and the tab is capable of abutting against the supporting bar to limit the closed position of the cover shell.

In some embodiments, at least one of the connecting portion and the tab has a dimension along the axial direction of the rotating shaft less than a dimension of the first panel body along the axial direction of the rotating shaft.

In some embodiments, the top panel defines an opening slot opened towards the connecting portion; when the cover shell is in the closed position, a portion of the connecting portion is arranged within the opening slot.

In some embodiments, the mounting base is an integrally-formed structure.

And/or, the connecting panel is an integrally-formed structure.

In some embodiments, when the cover shell is in the closed position, an outer surface of the shell body, a surface of the base body arranged in the first notch, and a surface of the connecting panel cooperatively form a smooth surface.

In some embodiments, the housing case comprises a elastic member, the cover shell has a critical position arranged between the closed position and the open position, and the elastic member is loaded between the mounting base and the connecting panel; when the cover shell is arranged in the critical position, a torque exerted by the elastic member on the case cover is zero; and when the cover shell deviates to either side of the critical position along a direction of rotation, the elastic member exerts a driving torque on the case cover to drive the cover shell to move to the closed position or the open position.

In some embodiments, the elastic member includes one or more torsion springs, and each of the one or more torsion springs comprises a first leg, a second leg, and a spiral body; the first leg and the second leg are connected to opposite sides of the spiral body in an axial direction, the first leg is connected to the base body, the second leg is connected to the connecting panel to drive the cover shell to rotate around an axis of the rotating shaft, and an angle between an axis of the spiral body and the axis of rotating shaft is in a range from 45° to 90°.

In some embodiments, the number of the one or more torsion springs is two, an end of the first leg of one of the torsion springs is fixedly connected to an end of the first leg of the other of the torsion springs, and the axis of the spiral body of one of the torsion springs is substantially parallel to the axis of the spiral body of the other of the torsion springs.

In some embodiments, the connecting panel defines insertion holes on both opposite sides of the connecting panel along an axial direction of the rotating shaft, an end of the second leg of one of the torsion springs is arranged in one of the insertion holes, and an end of the second leg of the other of the torsion springs is arranged in the other of the insertion holes.

In some embodiments, the shell body defines an insertion slot on an inner surface of the housing, the base body is capable of being inserted into the insertion slot from the top opening of the holding space, and the base body is supported on a bottom wall of the insertion slot.

In some embodiments, the case body comprises a first protrusion bar and two second protrusion bars, the first protrusion bar and the two second protrusion bars protrude from the inner surface of the shell body, the first protrusion bar extends in a direction substantially parallel to an axial direction of the rotating shaft, and each of the two second protrusion bars extends from a corresponding one of two opposite ends of the first protrusion bar toward the case cover; an end of one of the second protrusion bars away from the shell body is bent toward a side of the other of the second protrusion bars, the two second protrusion bars, the first protrusion bar, and the inner surface of the shell body cooperatively define the insertion slot, and the base body is supported on the first protrusion bar.

In some embodiments, the housing case comprises a storage panel abutting against a side of the base body facing the case cover, and the base body is fixed in the insertion slot via the storage panel.

In some embodiments, the housing case is an earphone charging box, earphones are stored in the holding space, and the earphone charging box is capable of charging the earphones.

In a further aspect, a housing case may be provided. The housing case includes a case, defining a first notch in a side wall of the case; a cover, connected to the case and having an open position at which the case is opened and a closed position at which the case is closed; a mounting base, mounted in the first notch, and comprising: a supporting bar; and two connecting bars, wherein one of the connecting bars is connected to one of the two opposite ends of the supporting bar, the other of the connecting bars is connected to the other of two opposite ends of the supporting bar, and the supporting bar and the two connecting bars cooperatively define a second notch; a connecting panel, connected to the cover and comprising: an intermediate portion; and an outer-edge portion, arranged at a periphery of the intermediate portion; and a rotating shaft, extending through the connecting panel and connected to the case to enable the cover to be switched between the open position and the closed position. When the cover is in the closed position, the outer-edge portion, the supporting bar, and the two connecting bars are enclosed together to define a ring structure, and the intermediate portion is arranged in the ring structure, such that the supporting bar, the two connecting bars, the outer-edge portion and the intermediate portion cooperatively close the first notch, while the outer-edge portion and the intermediate portion cooperatively close the second notch.

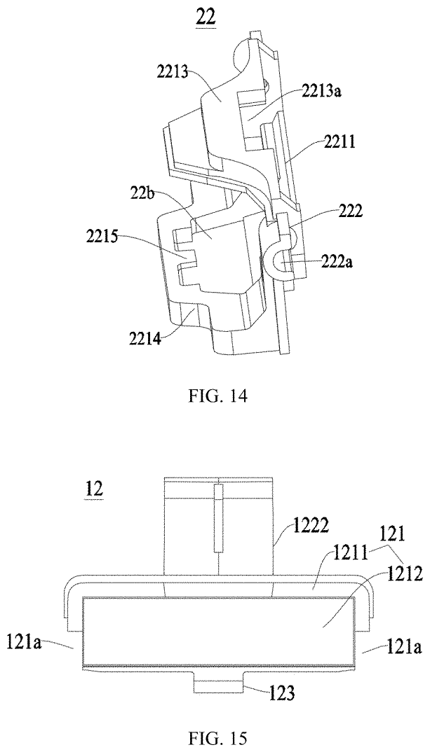

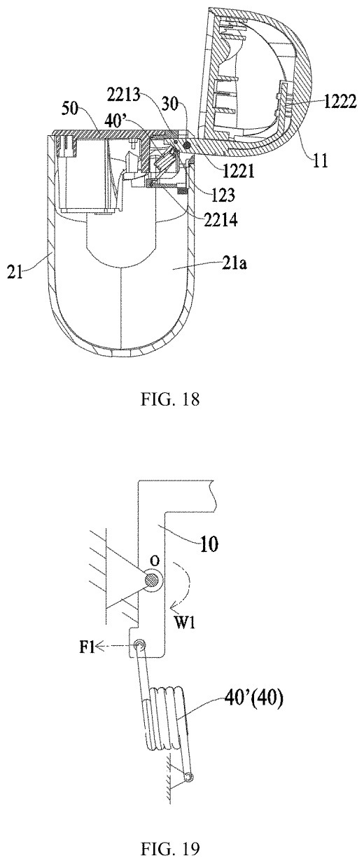

A rotating mechanism and a housing case provided in some embodiments of the present disclosure are described as following. As shown in FIGS. 8 to 16, the rotating mechanism provided in some embodiments of the present disclosure includes a connecting panel 12, a mounting base 22, and a rotating shaft 30. The connecting panel has a first position and a second position. The mounting base 22 includes a base body 221 and two protruding portions 222, one of the two protruding portions 222 extends along one of both sides of the base body 221, and the other of the two protruding portions 222 extends along the other of both sides of the base body 221. The base body 221 defines a second notch 221a, and the second notch 221a is defined between the two protruding portions 222. Each of the protruding portions 222 defines an accommodation slot 222a. The accommodation slot 222a is opened towards an outer side of the base body 221. That is, the accommodation slot 222a is opened toward a direction back from or away from the first position. When the connecting panel 12 is arranged in the first position, a portion of the connecting panel 12 is arranged on an inner side of the base body 221 (shown in FIG. 18). That is, the connecting panel 12 is arranged outside the second notch 221a and the portion of the connecting panel 12 does not close the second notch 221a. When the connecting panel 12 is arranged in the second position, the portion of the connecting panel 12 is arranged in the second notch 221a to close the second notch 221a (shown in FIG. 8). The rotating shaft 30 extends through the connecting panel 12 and the base body 221 and further extends into the accommodation slot 222a to enable the connecting panel 12 to be switched between the first position and the second position.

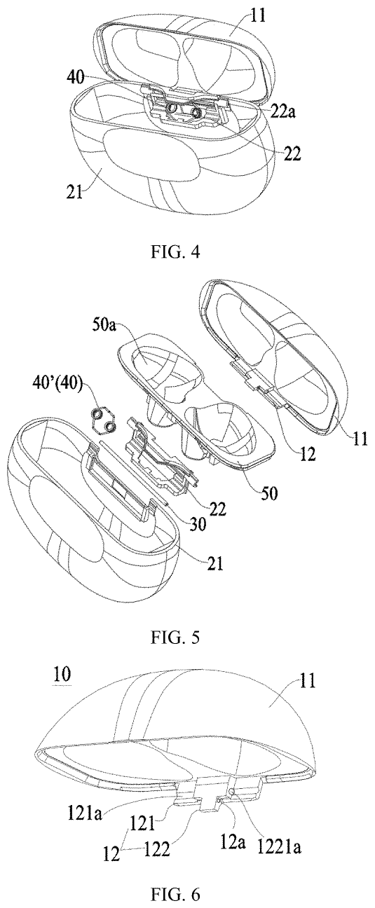

The connecting panel 12 rotates around the axis of the rotating shaft 30 relative to the mounting base 22. When the connecting panel 12 rotates around the axis of the rotating shaft 30 in a first direction, the connecting panel 12 may be arranged in the first position (as shown in FIG. 18). When the connecting panel 12 rotates around the axis of the rotating shaft 30 in a second direction, the connecting panel 12 may be arranged in the second position (as shown in FIG. 9). The mounting base 22 may be arranged on a housing. The housing may be a case body of a housing case, a panel, or a housing of another device that needs to achieve a rotational connection. The housing defines a first notch. The mounting base is disposed in the first notch of the housing, with the open portion of the accommodation slot 222a facing a side wall of the housing (as shown in FIG. 4), so that the accommodation slot 222a may be adopted to define a first shaft hole together with the side wall of the housing. Since the rotating shaft 30 extends into the accommodation slot 222a through the connecting panel 12 and the base body 221, that is, the rotating shaft 30 penetrates into the first shaft hole 22a (for example, regarding the housing as the case body of the housing case) through the connecting panel 12 and the base body 221, which means the rotating shaft 30 penetrates into the first shaft hole 22a through the connecting panel 12 and the base body 221 arranged in the first notch 21b, the base body 221 as well as the protruding portions 222 are adopted to bear a bending moment and torque. In this way, while ensuring that the mounting base 22 is able to bearing enough bending moment and torque, by applying the protruding portions 222 to bear most of the force from the rotating shaft 30, the size of a portion of the base body 221 connected to the rotating shaft 30 may be configured as small as possible, which means the size of the portion of the base body 221 arranged in the first notch 21b may be configured as small as possible. When the connecting panel 12 is in the second position, a user may observe the connecting panel 12 and the mounting base 22 from the outer side of the base body 221. With a small size of the portion of the base body 221 arranged in the first notch 21b, a visual effect of an integrated structure between the base body 221 and the connecting panel 12 may be achieved, avoiding a visual segmentation of the connecting panel 12 and the base body 221 caused by a situation that the portion of the base body 221 connected to the rotating shaft 30 has to be configured to be larger in order to ensure that the mounting base 22 is effectively stressed. From the perspective of industrial design, a structure in the embodiments of the present disclosure may greatly improve the aesthetics and increase the texture as well as product expression.

In some embodiments, the rotating mechanism in the embodiments of the present disclosure may be shown in FIGS. 8 to 16. The base body 221 includes a supporting bar 2211 and two connecting bars 2212. The connecting panel 12 includes a first panel body 121 and a second panel body 122. The supporting bar 2211 extends along an axial direction of the rotating shaft 30. That is, the supporting bar 2211 extends in a direction substantially parallel to the axial direction of the rotating shaft 30. In some embodiments, the supporting bar 2211 includes a step surface 2211a formed on an end face of the supporting bar 2211 facing toward an outer side of the mounting base 22. The step surface 2211a is supported on a bottom wall of the first notch of the housing. Each of the two connecting bars 2212 are connected to a corresponding end of the supporting bar 2211, respectively. The supporting bar 2211 and the two connecting bars 2212 cooperatively define or enclose the second notch 221a together. Each of the protruding portions 222 is connected to a corresponding one of the connecting bars 2212. The rotating shaft 30 extends through the connecting bars 2212 and further into the accommodation slot 222a. The first panel body 121 includes an intermediate portion 1211 and an outer-edge portion 1212. The outer-edge portion 1212 is arranged at a periphery of the intermediate portion 1211. The outer-edge portion 1212 defines an avoidance slot 121a on each of both opposite sides of the outer-edge portion 1212 along the axial direction of the rotating shaft 30. When the connecting panel 12 is in the second position, a portion of each of the connecting bars 2212 is arranged in the avoidance slot 121a. The outer-edge portion 1212, the supporting bar 2211, and the two connecting bars 2212 are enclosed together to form a ring structure. The intermediate portion 1211 is arranged in the ring structure. In this way, when the user observes the connecting panel 12 and the mounting base 22 from the outer side of the mounting base 22, a visual effect of an integrated structure among the outer-edge portion 1212, the supporting bar 2211, and the two connecting bars 2212 may be achieved. The second panel body 122 is connected to an inner end face of the first panel body 121. That is, the second panel body 122 is connected to an end face of the first panel body 121 near or close to the inner side of the base body 221. In some embodiments, the second panel body 122 includes a connecting portion 1221 and an extension portion 1222 extending from the connecting portion 1221 in a direction away from the mounting base 22. The connecting portion 1221 is connected to the inner end face of the first panel body 121. The extension portion 1222 is adopted as a force-bearing structure for connecting to an external structure. The second panel body 122 defines a second shaft hole 1221a disposed in the axial direction of the rotating shaft 30. The rotating shaft 30 penetrates the second shaft hole 1221a. In this way, by applying the second panel body 122 as the main force-bearing structure, the first panel body 121 may cover the second panel body 122 and the rotating shaft 30. In some embodiments, the second shaft hole 1221a may be defined in the connecting portion 1221. The supporting bar 2211 and the two connecting bars 2212 are mounted in the first notch 21b and connected to at least part of walls (including side walls, a bottom wall, etc.) defining the first notch 21b of the housing. In some embodiments, the supporting bar 2211 may be connected to the bottom wall defining the first notch 21b, and the two connecting bars 2212 may be connected to the side walls defining the first notch 21b. In some embodiments, it is also possible that the supporting bar 2211 is connected to both the bottom wall and the side walls defining the first notch 21b, or the two connecting bars 2212 may be connected to both the bottom wall and the side walls defining the first notch 21b, which is not limited in the present disclosure. The portion of each of the connecting bars 2212, a portion of the supporting bar 2211, and the first panel body 121 jointly or cooperatively close the first notch 21b. That is, when the rotating mechanism is arranged on the housing, the portion of each of the connecting bars 2212 and the portion of the supporting bar 2211 are both arranged in the first notch 21b of the housing, and further cooperate with the portion of the connecting panel 12 to close the first notch 21b of the housing. In this way, the side wall of the first notch 21b of the housing is adopted to limit a movement of the base body 221 along the axial direction of the rotating shaft 30, and the bottom wall of the first notch of the housing is adopted to limit a downward movement of the base body 221, thereby improving the structural stability of the mounting base 22.

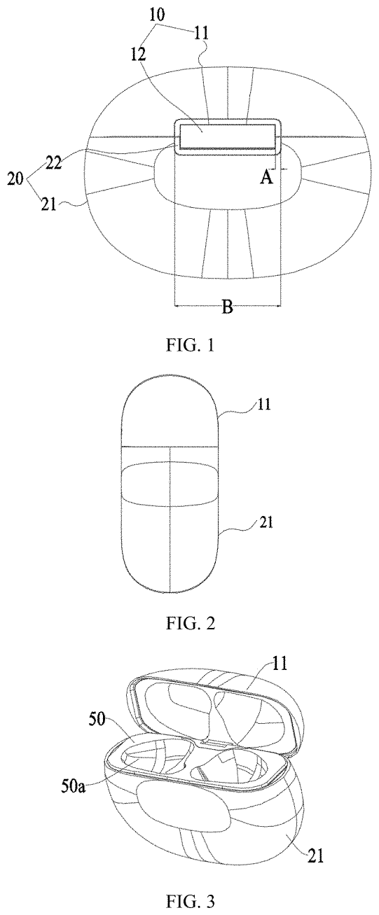

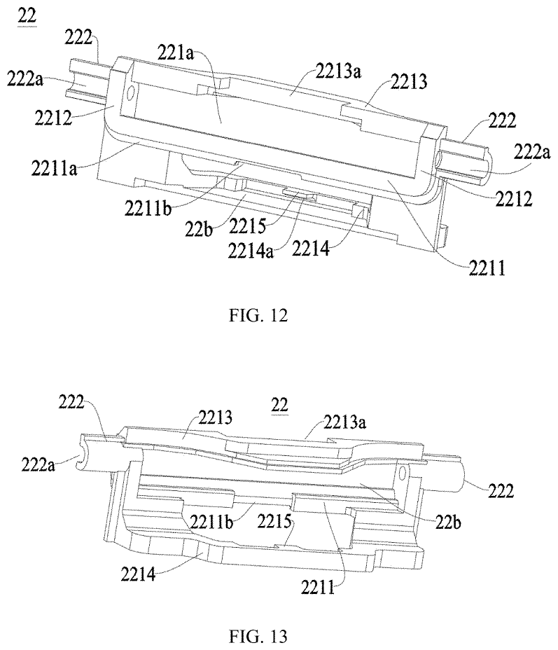

In some embodiments, the rotating mechanism provided in some embodiments of the present disclosure is adopted in a housing case, as shown in FIGS. 1 to 7. The housing case provided in some embodiments of the present disclosure includes a case cover 10, a case body 20, and a rotating shaft 30. The case cover 10 includes a cover shell 11 and a connecting panel 12 connected to the cover shell 11. The case body 20 includes a shell body 21 and a mounting base 22. The shell body 21 includes a holding space 21a opened at a top and a first notch 21b defined in a side wall of the shell body 21. The holding space 21a is fluidly connected to the first notch 21b. The mounting base 22 includes a base body 221 and two protruding portions 222, one of the two protruding portions 2222 extends along one of both sides of the base body 221, and the other of the two protruding portions 222 extends along the other of both sides of the base body 221 (shown in FIGS. 8 to 10). The base body 221 defines a second notch 221a (shown in FIG. 12). Each of the protruding portions 222 defines an accommodation slot 222a (shown in FIG. 12). The mounting base 22 is received or mounted in the first notch 21b and connected to the walls defining the first notch 21b. The protruding portions 222 are arranged in the holding space 21a. The accommodation slot 222a is opened towards the side wall of the shell body 21. The accommodation slot 222a and the side wall of the shell body 21 are enclosed together to form the first shaft hole 22a (shown in FIG. 4). The rotating shaft 30 extends through the connecting panel 12 and the base body 221 and further into the first shaft hole 22a to enable the cover shell 11 to be switched between an open position and a closed position of the shell body 21. While the cover shell 11 is in the closed position, a portion of the connecting panel 12 is arranged in the second notch 221a to close the second notch 221a, and a portion of the base body 221 and the portion of the connecting panel 12 cooperatively close the first notch 21b.

The case cover 10 may rotates around an axis of the rotating shaft 30 relative to the case body 20, so that the case cover 10 rotates around the axis of the rotating shaft 30 in a first direction, and the cover shell 11 may be arranged in the open position. In this way, items may be placed into the holding space 21a through a top opening of the holding space 21a. The case cover 10 may further rotate around the axis of the rotating shaft 30 in a second direction. In this way, the cover shell 11 is arranged in the closed position, and the cover shell 11 covers and closes the shell body 21. The portion of the base body 221 and the portion of the connecting panel 12 close the first notch 21b together, that is, the portion of the base body 221 and the portion of the connecting panel 12 are both arranged in the first notch 21b. The portion of the connecting panel 12 arranged in the first notch 21b is also arranged in the second notch 221a and closes the second notch 221a. During a rotation of the case cover 10 relative to the case body 20, the portion of the connecting panel 12 arranged in the second notch 221a moves toward an interior of the shell body 21 with avoidance of being collided with the second notch 221a and the first notch 21b, while the portion of the base body 221 arranged in the first notch 21b is fixed. The first shaft hole 22a is defined by the accommodation slot 222a and the side wall of the shell body 21 cooperatively. The rotating shaft 30 penetrates into the first shaft hole 22a through the connecting panel 12 and the base body 221, which means the rotating shaft 30 penetrates into the first shaft hole 22a through the portion of the connecting panel 12 and the base body 221 arranged in the first notch 21b. The base body 221 and the protruding portions 222 are adopted to bear the bending moment and torque together. In this way, while ensuring that the base body 221 is able to bearing enough bending moment and torque, by applying the protruding portions 222 to bear most of the force from the rotating shaft 30, the size of the portion of the base body 221 connected to the rotating shaft 30 may be configured as small as possible, which means the size of the portion of the base body 221 arranged in the first notch 21b may be configured as small as possible. In case that the cover shell 11 is in the closed position, when the user observes the case cover 10 and case body 20 from a side of the shell body 21 back from the protruding portions 222, most portions of the mounting base 22 are hidden in the shell body 21. With a small size of the portion of the base body 221 arranged in the first notch 21b, a visual effect of an integrated structure between the base body 221 and the connecting panel 12 may be achieved, avoiding a visual segmentation of the connecting panel 12 and the base body 221 caused by a situation that the portion of the base body 221 connected to the rotating shaft 30 has to be configured to be larger in order to ensure that the mounting base 22 is effectively stressed. From the perspective of industrial design, a structure in the embodiments of the present disclosure may greatly improve the aesthetics and increase the texture as well as product expression. In addition, the portion of the base body 221 arranged in the first notch 21b may be configured to limit the movement of the mounting base 22 along the axial direction of the rotating shaft 30. Further, since the accommodation slot 222a is opened towards the side wall of the shell body 21, the accommodation slot 222a and the side wall of the shell body 21 are jointly defined or enclosed to form the first shaft hole 22a. In this way, each of the protruding portions 222 may be attached closely to the side wall of the shell body 21, reducing a distance between each of the protruding portions 222 and the side wall of the shell body 21, avoiding the mounting base 22 from occupying too much space in the case body 20, thereby making a structure of the case body 20 more compact.

It should be noted that the second direction is opposite to the first direction. Exemplarily, when the first direction is clockwise, the second direction is counterclockwise. When the first direction is counterclockwise, the second direction is clockwise. The inner side of the base body 221 is a side of the shell body 21 near or close to the holding space 21a. In contrast, the outer side of the base body 221 is a side of the shell body 21 away from the holding space 21a. That is, the inner side of the base body 221 and the outer side of the base body 221 refer to two opposite sides of the base body 221. For the purpose of the description of the present disclosure, the embodiments of the present disclosure define the inner side of the base body 221 and the outer side of the base body 221.

It will be understood that the rotating mechanism provided in some embodiments of the present disclosure is adopted for the housing case. The connecting panel 12 of the rotating mechanism being in the first position means the cover shell 11 of the housing case is in the open position. The connecting panel 12 in the rotating mechanism being in the second position means the cover shell 11 of the housing case is in the closed position.

In some embodiments, as shown in FIGS. 1 to 7, the housing case is an earphone charging box, and earphones are able to be stored in the holding space 21a. The earphone charging box is capable of charging the earphones. Since the case body 20 is not only adopted to accommodate the earphones but also adopted to configure a power supply, a circuit board, charging contacts, and other structures applied to charge the earphones, there are multiple components in the case body 20, causing the space in the case body 20 for holding the mounting base 22 relatively small. However, the mounting base 22 in the embodiments of the present disclosure is compact and applicable for the small space in the shell body 21 of the earphone charging box.

The earphone charging box is configured to charge matching earphones. In some embodiments, the earphone charging box includes an internal power supply for storing electricity. When the earphones are arranged in the earphone charging box, the power supply for storing electricity may charge the earphones. The earphones in the embodiments of the present disclosure may be paired and connected with intelligent terminals such as cell phones, tablets, etc. Audios may be automatically switched to the earphones when the user uses the intelligent terminals. The earphones may be Bluetooth earphones, infrared earphones, etc., and without limited herein.

In some embodiments, as shown in FIGS. 8 to 14, the base body 221 includes a supporting bar 2211 and connecting bars 2212. The supporting bar 2211 extends along the axial direction of the rotating shaft 30. The supporting bar 2211 includes the step surface 2211a formed on an end face of the supporting bar 2211 facing toward the outer side of the shell body 21. The step surface 2211a is supported on a bottom wall of the first notch 21b. Each of the two connecting bars 2212 are connected to a corresponding end of the supporting bar 2211, respectively. The supporting bar 2211 and the two connecting bars 2212 cooperatively define or enclose the second notch 221a. Each of the protruding portions 222 is connected to corresponding one of the connecting bars 2212. The rotating shaft 30 extends through the connecting bars 2212 and further extends into the first shaft hole 22a. The supporting bar 2211 and the two connecting bars 2212 are connected to the first notch 21b. That is, a portion of each of the connecting bars 2212 and a portion of the supporting bar 2211 are both arranged in the first notch 21b, and further cooperate with the portion of the connecting panel 12 to close the first notch 21b. In this way, the side wall of the first notch 21b is adopted to limit the movement of the base body 221 along the axial direction of the rotating shaft 30, and the bottom wall of the first notch 21b is adopted to limit the downward movement of the base body 221, thereby improving the structural stability of the mounting base 22.

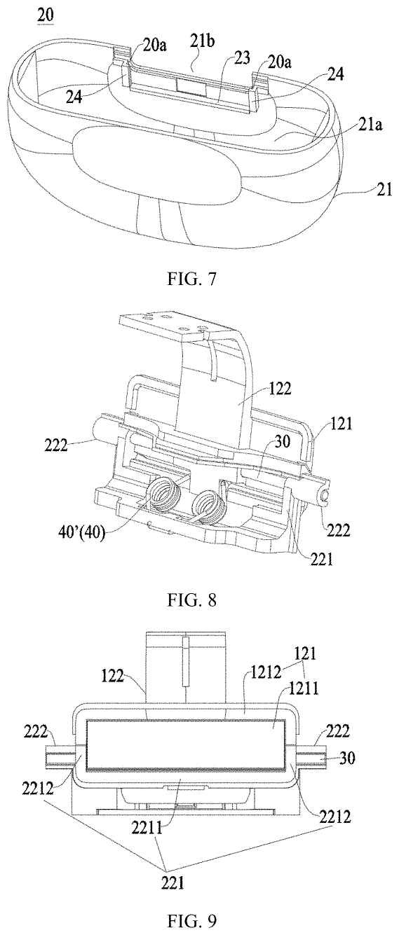

In some embodiments, as shown in FIG. 1, FIG. 7, FIG. 9, and FIG. 12, a length of the portion of each of the connecting bars 2212 (shown in FIG. 7) arranged in the first notch 21b (shown in FIG. 12) along the axial direction of the rotating shaft 30 (shown in FIG. 9) is defined as A, and 0.5 mm≤A≤1.2 mm. For example, A may be 0.5 mm, 0.8 mm, 1.0 mm, 1.1 mm, or 1.2 mm, etc. In some embodiments, a length of the first notch 21b along the axial direction of the rotating shaft 30 is defined as B, and 1/25≤A/B≤1/15. For example, a ratio of A to B may be 1:25, 1:24, 1:23, 1:21, 1:20, 1:18, 1:15, etc. In this way, under the condition of ensuring the force-bearing capacity of the portion of the base body 221 arranged in the first notch 21b, the length of the portion of each of the connecting bars 2212 arranged in the first notch 21b along the axial direction of the rotating shaft 30 is small enough to achieve the visual effect of nearly complete integration between the portion of each of the connecting bars 2212 arranged in the first notch 21b and the connecting panel 12, thereby further improving the aesthetics.

In some embodiments, as shown in FIGS. 8 to 11 and FIGS. 15 to 16, the connecting panel 12 includes a first panel body 121 and a second panel body 122. The first panel body 121 defines an avoidance slot 121a on each of both opposite sides along the axial direction of the rotating shaft 30. While the cover shell 11 is in the closed position, a portion of each of the connecting bars 2212 is arranged in the avoidance slot 121a. The portion of each of the connecting bars 2212, the portion of the supporting bar 2211, and the first panel body 121 cooperatively close the first notch 21b. The second panel body 122 includes a connecting portion 1221 and an extension portion 1222 extending from the connecting portion 1221 toward the case cover 10. The connecting portion 1221 is connected to a side of the first panel body 121 near or close to the holding space 21a. The extension portion 1222 is connected to the cover shell 11. The connecting portion 1221 defines a second shaft hole 1221a in the axial direction of the rotating shaft 30. The rotating shaft 30 penetrates into the second shaft hole 1221a.

The rotating shaft 30 penetrates into the second shaft hole 1221a and the first shaft hole 22a, enabling the rotating shaft 30 to connect the second panel body 122 and the protruding portions 222. In this way, the second panel body 122 is configured to bear the bending moment and torque, which means the second panel body 122 is the main force-bearing structure. Further, the extension portion 1222 is connected to the cover shell 11 in order to enhance the force-bearing capacity of the second panel body 122. Since the connecting portion 1221 is connected to the side of the first panel body 121 near the holding space 21a, the first panel body 121 may cover the rotating shaft 30, the connecting portion 1221, and other structures of the base body 221 to prevent the internal structure of the case body 20 from being observed by the user from the side of the first panel body 121 back from the holding space 21a, and the aesthetics of the housing case is improved.

In some embodiments, the extension portion 1222 is connected to the cover shell 11. In some embodiments, the extension portion 1222 is connected to the cover shell 11 by welding the extension portion 1222 on the cover shell 11. In some embodiments, the extension portion 1222 is connected to the cover shell 11 by a connection member, which may be a bolt (shown in FIG. 17 and FIG. 18). This facilitates the assembling of the connecting panel 12 with the cover shell 11 and disassembling of the connecting panel 12 from the cover shell 11.

In some embodiment, as shown in FIGS. 9, 10 and 15, the first panel body 121 includes an intermediate portion 1211 and an outer-edge portion 1212. The outer-edge portion 1212 is arranged at a periphery of the intermediate portion 1211. The outer-edge portion 1212 defines the avoidance slot 121a. The outer-edge portion 1212, the supporting bar 2211, and the two connecting bars 2212 are enclosed together to form a ring structure. The intermediate portion 1211 is arranged in the ring structure. In this way, in case that the cover shell 11 is in the closed position, when the user observes the case cover 10 and the case body 20 from the side of the shell body 21 back from or away from the holding space 21a, the outer-edge portion 1212, the supporting bar 2211, and the connecting bars 2212 present the visual effect of an integrated structure.

In some embodiments, the ring structure may be substantially circular, oval, or polygonal, etc. The polygon may be quadrilateral, pentagonal, hexagonal, etc. In some embodiments, the ring structure is a rectangle.

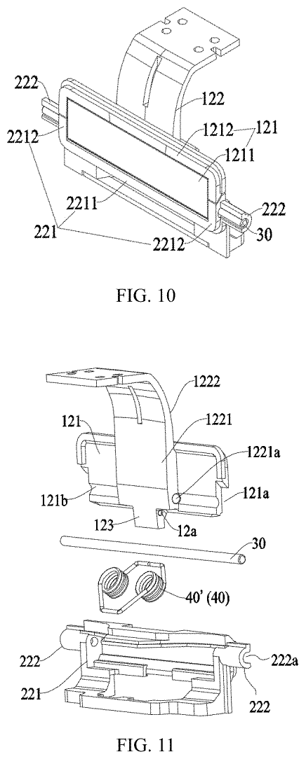

In some embodiments, as shown in FIGS. 9 and 10, on a plane on which the first panel body 121 is arranged, a projection pattern formed by the supporting bar 2211 and the two connecting bars 2212 together is symmetric with a projection pattern formed by the outer-edge portion 1212. In this way, the aesthetic appearance is further improved.

In some embodiments, as shown in FIGS. 9, 10, and 15, a contact seam between the supporting bar 2211 and the outer-edge portion 1212 is substantially flush with a contact seam between the cover shell 11 and the shell body 21. In this way, the visual effect of misalignment between the supporting bar 2211 and the outer-edge portion 1212 and the cover shell 11 and the shell body 21 is avoided, further improving aesthetics.

In some embodiments, as shown in FIGS. 9, 10, and 15, the intermediate portion 1211 defines a recessed platform on an end face of the intermediate portion 1211 back from the holding space 21a. The housing case includes a panel arranged on the recessed platform. The panel may be a display screen or an information sticker. The information sticker is a sticker containing warning information, product information, or other information. With the above design, the information may be conveyed by making full use of the end face of the intermediate portion 1211 back from the holding space 21a.

In some embodiments, the recessed platform may be circular, oval, or polygonal, etc. The polygon may be quadrilateral, pentagonal, hexagonal, etc. In some embodiments, the recessed platform is rectangular.

In some embodiments, as shown in FIGS. 9, 10, and 15, an end face of the outer-edge portion 1212 back from or away from the holding space 21a, an end face of the supporting bar 2211 back from the holding space 21a, and an end face of each of the connecting bars 2212 back from the holding space 21a may be configured in a first color. In this way, the outer-edge portion 1212, the supporting bar 2211, and the connecting bars 2212 present an integrated structure. In some embodiments, the end face of the intermediate portion 1211 back from the holding space 21a is configured in a second color. The first color and the second color are configured to be different from each other, so that the difference between the first color and the second color is adopted to enable the outer-edge portion 1212, the supporting bar 2211, and the connecting bars 2212 to present the visual effect of an integrated structure. In some embodiments, the first color may also be the same as the second color. In this way, the intermediate portion 1211, the outer-edge portion 1212, the supporting bar 2211, and the connecting bars 2212 together present the visual effect of an integrated structure. Exemplarily, the first color may be gold and the second color may be silver.

In some embodiments, as shown in FIGS. 9, 10 and 15, the end face of the outer-edge portion 1212 back from the holding space 21a, the end face of the supporting bar 2211 back from the holding space 21a, and the end face of each of the connecting bars 2212 back from the holding space 21a may be configured in a first texture. In this way, the outer-edge portion 1212, the supporting bar 2211 and the connecting bars 2212 present an integrated structure. Further, the end face of the intermediate portion 1211 back from the holding space 21a is configured in a second texture. The first texture and the second texture are configured to be different from each other, so that the difference between the first texture and the second texture is adopted to enable the outer-edge portion 1212, the supporting bar 2211, and the connecting bar 2212 to present the visual effect of an integrated structure. In some embodiments, the first texture may also be the same as the second texture. In this way, the intermediate portion 1211, the outer-edge portion 1212, the supporting bar 2211, and the connecting bars 2212 together present the visual effect of an integrated structure. Exemplarily, the first texture may be diagonal, tic-tac-toe, diamond-shaped, etc. The second texture may also be diagonal, tic-tac-toe, diamond-shaped, etc.

In some embodiments, as shown in FIGS. 4 and 5, the rotating shaft 30 may be a long shaft which penetrates through the first shaft hole 22a, the second shaft hole 1221a, and the base body 221. The rotating shaft 30 may also include two short shafts. One of the two short shafts extends through one first shaft hole 22a and one side of the base body 221 and further extends into the second shaft hole 1221a, while the other of the two short shafts extends through the other first shaft hole 22a and the other side of the base body 221 and further extends into the second hole 1221a. All of the above ways may be adopted to connect the connecting panel 12 and the mounting base 22 by means of the rotating shaft 30.

In other embodiments, the two short shafts may also be connected to both opposite sides of the connecting panel 12. With each of the two short shafts extending into the corresponding first shaft hole 22a, the connecting panel 12 and the mounting base 22 are pivoted to each other.

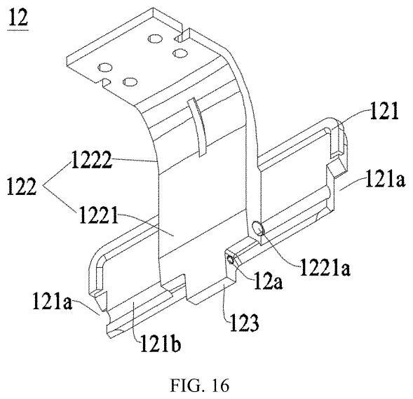

In some embodiments, as shown in FIGS. 11 and 16, an end face of the first panel body 121 facing the holding space 21a defines a groove 121b. The groove 121b extends in the axial direction of the rotating shaft 30, and a portion of the rotating shaft 30 is arranged in the groove 121b. In this way, a distance between the end face of the first panel body 121 facing the holding space 21a and the rotating shaft 30 is convenient to be reduced, making the structure of the mounting base 22 more compact. In addition, during the rotation of the connecting panel 12, the cooperation of the groove 121b and the rotating shaft 30 also acts as a rotation guide, enabling a rotation process of the connecting panel 12 to be smoother and more stable.

In some embodiments, a wall surface of the groove 121b is adapted to or matches with an outer surface of the rotating shaft 30. In other words, when the rotating shaft 30 is cylindrical, the wall surface of the groove 121b may be a curved surface that matches with the outer surface of the rotating shaft 30.

In some embodiments, as shown in FIGS. 13 to 18, the second panel body 122 includes a tab 123 extending from the connecting portion 1221 toward the base body 221. The base body 221 includes a top panel 2213 connected to a top of each of the connecting bars 2212. The supporting bar 2211 and the top panel 2213 cooperatively define a rotating space 22b. The rotating shaft 30 is arranged between the top panel 2213 and the supporting bar 2211 along a height direction of the base body 221. The tab 123 is capable of rotating around the axis of the rotating shaft 30 within the rotating space 22b. The tab 123 is capable of abutting against the top panel 2213 to define and limit the open position of the cover shell 11, and the tab 123 is capable of abutting against the supporting bar 2211 to define and limit the closed position of the cover shell 11. The supporting bar 2211 is capable of stopping and contacting with or abutting against the tab 123 to define the closed position of the cover shell 11, and the top panel 2213 is capable of stopping and contacting with or abutting against the tab 123 to define the open position of the cover shell 11. In this way, it is not only possible to keep the cover shell 11 in the closed position and the open position stably, but also to define and limit an opening angle of the cover shell 11. Exemplarily, the opening angle of the cover shell 11 may be limited by controlling a tilt angle of the top panel 2213 or by defining recessed areas 2214a in different depths on the top panel 2213, for example, the opening angle may be 80°, 90°, 100°, etc., so as to facilitate taking items from the holding space 21a or placing items into the holding space 21a.

In some embodiments, as shown in FIG. 16, a dimension of the connecting portion 1221 along the axial direction of the rotating shaft 30 is less than a dimension of the first panel body 121 along the axial direction of the rotating shaft 30. The design facilitates the first panel body 121 to cover up the connecting portion 1221.

In some embodiments, as shown in FIG. 16, a dimension of the tab 123 along the axial direction of the rotating shaft 30 is less than the dimension of the first panel body 121 along the axial direction of the rotating shaft 30. The design facilitates the rotation of the tab 123 within the rotating space 22b and avoids other structures of the base body 221 from interfering with a movement of the tab 123.

In some embodiments, as shown in FIGS. 12 to 14, the top panel 2213 defines an opening slot 2213a opened toward the connecting portion 1221. While the cover shell 11 is in the closed position, a portion of the connecting portion 1221 is arranged in the opening slot 2213a. The opening slot 2213a defines an avoidance space for the connecting portion 1221 to avoid the connecting portion 1221 from interfering with the top panel 2213 during rotation, allowing the connecting panel 12 to rotate in a larger rotation range.

In some embodiments, as shown in FIGS. 12 to 14, the mounting base 22 is integrally formed as a one-piece structure. In this way, a structural strength between constituent components of the mounting base 22 is enhanced, and the processes are reduced. In some embodiments, the mounting base 22 may also be a split structure with the constituent components connected to each other, such as by welding.

In some embodiments, as shown in FIGS. 15 to 16, the connecting panel 12 is integrally formed as a one-piece structure. In this way, a structural strength between the constituent components of the connecting panel 12 is enhanced, and the processes are reduced. In some embodiments, the connecting panel 12 may also be a split structure with the constituent components connected to each other, such as by welding.

The mounting base 22 and the connecting panel 12 provided in some embodiments of the present disclosure may be made of metal materials in order to increase the texture, improve the aesthetics, and further increase the product expression. In some embodiments, the mounting base 22 and the connecting panel 12 may also be made of plastic in order to reduce weight. The embodiments of the present disclosure do not limit the materials of the mounting base 22 and the connecting panel 12.

In some embodiments, as shown in FIGS. 1 and 2, while the cover shell 11 is in the closed position, an outer surface of the shell body 21, a surface of the base body 221 arranged in the first notch 21b, and a surface of the connecting panel 12 cooperatively form a smooth surface. That is, the base body 221 arranged in the first notch 21b and the connecting panel 12 arranged in the first notch 21b may not protrude out of nor be lower than the outer surface of the shell body 21. The design not only improves the aesthetics, but also facilitates the user to have a better touching feeling when gripping the shell body 21 without feeling sharp corners or protruding structures.

In some embodiments, as shown in FIGS. 4 to 5 and FIGS. 17 to 20, the housing case includes an elastic member 40. The cover shell 11 has a critical position. The critical position is arranged between the closed position and the open position. The elastic member 40 is loaded between the mounting base 22 and the connecting panel 12. That is, for the elastic member 40, both the mounting base 22 and the connecting panel 12 are loaded by the elastic member 40. While the cover shell 11 is arranged in the critical position, the elastic member 40 imposes a zero torque on the case cover 10. While the cover shell 11 deviates to either side of the critical position along the direction of rotation, the elastic member 40 imposes a driving torque on the case cover 10 to drive the cover shell 11 to the closed position or the open position.

It should be noted that the expressions “while the cover shell 11 deviates to either side of the critical position along the direction of rotation, the elastic member 40 imposes a driving torque on the case cover 10 to drive the cover shell 11 to the closed position or the open position” includes the following two cases. The first case is: while the cover shell 11 deviates from the critical position and is located on a first side of the critical position along the direction of rotation, the elastic member 40 drives the cover shell 11 to the open position. The second case is: while the cover shell 11 deviates from the critical position and is located on a second side of the critical position along the direction of rotation, the elastic member 40 drives the cover shell 11 to the closed position.

In some embodiments, as shown in FIG. 19, the elastic member 40 applies a force F1 to the case cover 10, and the force F1 generates a first torque W1 around the axis of the rotating shaft 30 (simplified as the point O shown in FIG. 19). The first torque W1 is the driving torque described above. The cover shell 11 moves to the closed position and remains in the closed position under the effect of the first torque W1. That is, when there is no external force acting on the case cover 10 or when the external force acting on the case cover 10 is not sufficient to overcome the resistance formed by the first torque W1, the cover shell 11 may not deviate from the current closed position.

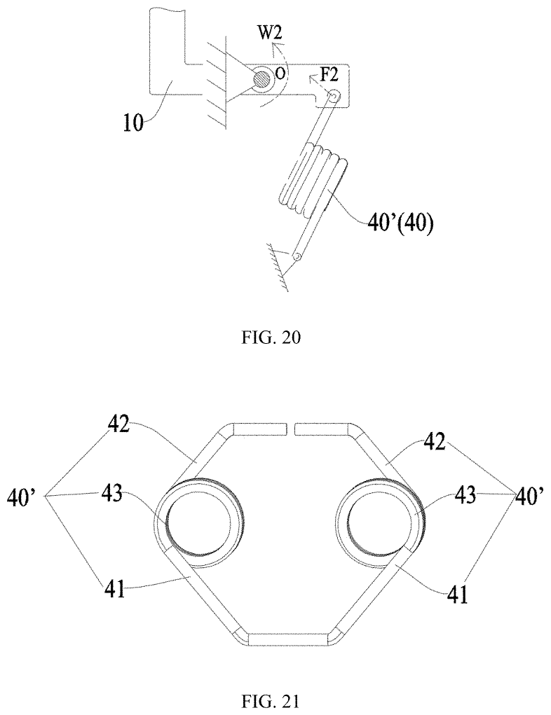

As shown in FIG. 20, the elastic member 40 applies a force F2 to the case cover 10, and the force F2 generates a second torque W2 around the axis of the rotating shaft 30 (simplified as the point O in FIG. 20). The second torque W2 is the driving torque described above. The first torque W1 is in an opposite direction to the second torque W2. The cover shell 11 moves to the open position and remains in the open position under the effect of the second torque W2. That is, when there is no external force acting on the case cover 10 or when the external force acting on the case cover 10 is not sufficient to overcome the resistance formed by the second torque W2, the cover shell 11 may not deviate from the current open position.

When the cover shell 11 needs to be switched from the closed position to the open position, the user may slowly rotate the case cover 10, and the force applied by the user needs to be able to overcome the resistance provided by the first torque W1 at this time. That is, the first torque W1 is a resistance torque in this case. When an angle of rotation of the cover shell 11 is able to enable the cover shell 11 to cross the above-mentioned critical position, the elastic member 40 applies the reverse second torque W2 to the case cover 10. The direction of the second torque W2 is the same as the direction of rotation. The second torque W2 is the driving torque in this case. Even if being released by the user, the cover shell 11 may automatically rotate under the effect of the elastic member 40 until the cover shell 11 reaches the open position, and stably remains in the open position under the effect of the second torque W2.

When the cover shell 11 needs to be switched from the open position to the closed position, the user may slowly rotate the case cover 10 in a reverse direction, and the force applied by the user needs to be able to overcome the resistance provided by the second torque W2 at this time. That is, the second torque W2 is a resistance torque in this case. When the angle of rotation of the cover shell 11 is able to enable the cover shell 11 to cross the above-mentioned critical position, the elastic member 40 applies the reverse first torque W1 to the case cover 10. Even if being released by the user, the cover shell 11 may automatically rotate under the effect of the elastic member 40 until the cover shell 11 reaches the closed position, and stably remains in the closed position under the effect of the first torque W1.

In other words, within a certain rotation range, the cover shell 11 has functions of automatic closing and automatic opening, and the closing process and the opening process have a damping feel, which is conducive to enhancing the users' experience.

In some embodiments, as shown in FIG. 21, the elastic member 40 includes at least one torsion spring 40′. The torsion spring 40′ includes a first leg or outrigger 41, a second leg or outrigger 42, and a spiral body 43. The first leg 41 and the second leg 42 are connected to opposite sides of the spiral body 43 in an axial direction of the spiral body 43. The first leg 41 is connected to the base body 221, and the second leg 42 is connected to the connecting panel 12 to drive the cover shell 11 to rotate around the axis of the rotating shaft 30. In other words, the second leg 42 of the torsion spring 40′ is not only able to drive the cover shell 11 to rotate around the axis of the rotating shaft 30 in the first direction, but also able to drive the cover shell 11 to rotate around the axis of the rotating shaft 30 in the second direction. The first direction is opposite to the second direction. The angle between the axis of the spiral body 43 and the axis of the rotating shaft 30 is configured in a range from 45° to 90°. In this way, the space occupied by the torsion spring 40′ along a direction substantially perpendicular to the axis of the rotating shaft 30 may be reduced, making the housing case compact.

In some embodiments, the spiral body 43 is disposed in suspension, that is, the spiral body 43 may move with the second leg 42.

It is understood that the torsion spring 40′ may form the first torque W1 described above in a compression state or a tensile state. Further, the torsion spring 40′ may form the second torque W2 described above in a compression state or a tensile state, which is not limited herein.

During the rotating of the cover shell 11, a distance between an end of the first leg 41 and an end of the second leg 42 changes, which causes a screw pitch of the spiral body 43 to change. That is, the spiral body 43 has an elastic deformation along the axial direction of the spiral body 43, so that the spiral body 43 obtains a rebound force along its axial direction. The rebound force is applied to the case cover 10 to form the above-mentioned forces F1 and F2. Since the above-mentioned forces F1 and F2 are generally in the axial direction of the spiral body 43, the directions of the forces are relatively certain. Therefore, in a designing process of the torsion spring 40′, a diameter, material, a size of the screw pitch, etc. of the spiral body 43 are easily designed.

In some embodiments, the axis of the spiral body 43 is substantially perpendicular to the axis of the rotating shaft 30. That is, the angle between the axis of the spiral body 43 and the axis of the rotating shaft 30 is approximately 90°. Since the torsion spring 40′ relies on the force formed by the elastic deformation of the spiral body 43 in the axial direction, even if the maximum distance between the end of the first leg 41 and the end of the second leg 42 is configured to be relatively small, the torsion spring 40′ is able to apply a large elastic force on the case cover 10. Therefore, the torsion spring 40′ has a relatively small size in the height direction (top-to-bottom direction) and the width direction (left-to-right direction) shown in FIG. 17, thereby making the housing case more compact.

It can be understood that the number of torsion springs 40′ may be one or plurality. The “plurality” includes two and more. It is to be noted that in embodiments where there is a plurality of torsion springs 40′, the plurality of torsion springs 40′ may be spaced apart from each other without interfering with each other, or may be connected to each other.

It should be noted that in an embodiment with only one torsion spring 40′, both the first leg 41 and the second leg 42 mentioned above create component forces in the axial direction of the rotating shaft 30, and both of component forces have the same direction. The component forces may force the case cover 10 to move in the axial direction of the rotating shaft 30, creating a sense of wobbling and unstable for users. In this case, in some embodiments, as shown in FIGS. 4, 5 and 21, the number of torsion springs 40′ is two. The end of the first leg 41 of one torsion spring 40′ is fixedly connected to the end of the first leg of the other torsion spring 40′. The axis of the spiral body 43 of one torsion spring 40′ is substantially parallel to the axis of the spiral body 43 of the other torsion spring 40′. That is, the two torsion springs 40′ form a structure of a double torsion spring. On the one hand, the double torsion spring may have a high structural strength, a large torque, a good stability, as well as a long lifetime, may further be difficult to deform when being applied with large forces, and may be able to improve the reliability and durability of the housing case. On the other hand, directions of the two component forces created by the double torsion spring in the axial direction of the rotating shaft 30 are reverse, and are able to cancel each other out, thereby enabling the case cover 10 to be centered at the middle position along the axis of the rotating shaft 30. In some embodiments, due to manufacturing errors, assembly errors, etc., a certain axial clearance exists between the case cover 10 and the mounting base 22 in the axial direction of the rotating shaft 30. The axial clearance ensures that the case cover 10 and the mounting base 22 may be properly assembled with each other without providing a large dry friction between the case cover 10 and the mounting base 22. Due to the existence of this axial clearance, the case cover 10 is possible to be displaced or moved along the axial direction. Under the effects of the above two torsion springs 40′, when the case cover 10 is arranged in the middle position, forces of the two torsion springs 40′ along the axial direction are balance. When the case cover 10 moves by a small distance to the left side shown in FIG. 21, the torsion spring 40′ on the right side may force the case cover 10 move to the right. When the case cover 10 moves by a small distance to the right side shown in FIG. 21, the torsion spring 40′ on the left side may force the case cover 10 to move to the left, and so on. The case cover 10 is stabilized in a middle balance position. In this way, even if the case cover 10 has a large axial clearance on both sides of the case cover 10 along the axial direction, the case cover 10 may not be displaced along the axial direction, which may reduce requirements of a manufacturing accuracy and an assembly accuracy of the case cover 10 and the mounting base 22, thereby facilitating reducing product costs.

In some embodiments of the present disclosure, as further shown in FIG. 21, both the first leg 41 and the second leg 42 have bent structures. The two torsion springs 40′ generally constitute a regular hexagonal structure.

In some embodiments, as shown in FIG. 11 and FIG. 16, the connecting panel 12 defines two insertion holes 12a, one of the insertion holes 12a is disposed on one of both opposite sides of the connecting panel 12 along the axis of the rotating shaft 30, and the other of the insertion holes 12a is disposed on the other side of both opposite sides of the connecting panel 12 along the axis of the rotating shaft 30. The end of the second leg 42 of one of the torsion springs 40′ is arranged in one of the insertion holes 12a, while the end of the second leg 42 of the other torsion spring 40′ is arranged in the other of insertion hole 12a. During the rotation of the case cover 10 around the axis of the rotating shaft 30, the end of the second leg 42 of the torsion spring 40′ may be rotated within the insertion hole 12a to improve the force-bearing conditions of the torsion spring 40′ itself.

In some embodiments, as shown in FIG. 11 and FIG. 16, the two insertion holes 12a are arranged in a same line, for example, central axes of the two insertion holes 12a coincides with each other. The line connecting the two insertion holes 12a is substantially parallel to the axis of the rotating shaft 30.

In some embodiments, as shown in FIG. 11 and FIG. 16, the two insertion holes 12a are formed on opposite sides of the tab 123 in the axial direction of the rotating shaft 30, respectively. The dimension of the tab 123 along the axial direction of the rotating shaft 30 is less than the dimension of the first panel body 121 along the axial direction of the rotating shaft 30. In this way, the distance between the ends of the second legs 42 of the two torsion springs 40′ is relatively small, thereby facilitating the installation of the torsion springs 40′. Further, as shown in FIGS. 12 and 13, an avoidance notch 2211b is defined at a position of the supporting bar 2211 at which the supporting bar 2211 abuts against the tab 123. When the cover shell 11 is in the closed position, a portion of the tab 123 is arranged in the avoidance notch 2211b. In this way, not only the tab 123 and the supporting bar 2211 may be effectively cooperated with each other, but also a thickness of the tab 123 along the direction substantially perpendicular to the axial direction of the rotating shaft 30 is relatively great, which facilitates the configuring of the insertion hole 12a in the tab 123 and avoids a hole wall of the insertion hole 12a being too thin.

In some embodiments, as shown in FIGS. 12 and 13, the base body 221 includes a bottom panel 2214 connected to a bottom end of each of the connecting bars 2212. A top surface of the bottom panel 2214 defines a recessed area 2214a. The base body 221 further includes a stopper 2215 arranged on a top side of the recessed area 2214a. The stopper 2215 and a surface of the recessed area 2214a define a limiting slot together. The first leg 41 of the torsion spring 40′ is movably arranged in the limiting slot. In other words, in the embodiments, when assembling, it is only necessary to snap or engage the first leg 41 of the torsion spring 40′ into the limiting slot, and the stopper 2215 may prevent the first leg 41 from detaching from the bottom panel 2214 from the top side of the recessed area 2214a.

In some embodiments, as shown in FIG. 7, an inner surface of the shell body 21 defines an insertion slot 20a. The base body 221 is able to be inserted into the insertion slot 20a from the top opening of the holding space 21a. The base body 221 is supported on a bottom wall of the insertion slot 20a. During the assembly, the base body 221 may be first inserted downward from the top opening of the holding space 21a into the insertion slot 20a. The insertion slot 20a may limit not only the downward movement of the base body 221, but also the movements of the base body 221 along and perpendicular to the axial direction of the rotating shaft 30, which means the insertion slot 20a limits the movements of the base body 221 in the down, front, back, left, and right directions shown in the FIG. 7. In this way, the fixed installation of the base body 221 may be achieved without the use of fastening methods such as screws and gluing, and further without the requirement of additional fasteners. Therefore, the method implemented in the fixed installation is reliable and time-saving.

In some embodiments, as shown in FIGS. 3 and 5, the housing case further includes a storage panel 50, and the storage panel 50 defines a storage slot 50a. The storage panel 50 is pressed or abuts against the side of the base body 221 facing the case cover 10 to fix the base body 221 in the insertion slot 20a. After the base body 221 is inserted into the insertion slot 20a, the storage panel 50 is pressed against the side of the base body 221 facing the case cover 10, and the storage panel 50 is configured to fix the base body 221 in the insertion slot 20a. That is, the storage panel 50 may limit an upward movement of the base body 221 and prevent the base body 221 from coming out of the top side of the insertion slot 20a. When the storage case is the earphone charging box, the earphones are arranged in the storage slot 50a.

In some embodiments, as shown in FIG. 7, the case body 20 includes a first protrusion bar 23 and two second protrusion bars 24 protruding from the inner surface of the shell body 21. The first protrusion bar 23 extends in a direction substantially parallel to the axis of the rotating shaft 30. The two second protrusion bars 24 extend from both opposite ends of the first protrusion bar 23 toward the shell body 21. An end of one of the second protrusion bars 24 away from the shell body 21 is bent toward a side of the other of the second protrusion bars 24. The two second protrusion bars 24, the first protrusion bar 23, and the inner surface of the shell body 21 cooperatively defines the insertion slot 20a. The base body 221 may be supported on the first protrusion bar 23. In this way, it may be quickly and easily manufactured to form the insertion slot 20a.

The above mentioned is only an implementation of the present disclosure, but the scope of protection of the present disclosure is not limited herein. Any skilled familiar with the art may easily think of changes or substitutions within the technical scope disclosed in the present disclosure, all the changes or substitutions should be covered by the scope of protection of the present disclosure. Therefore, the scope of protection of this disclosure shall be subject to the scope of protection of the claims.

What is claimed is:

1. A rotating mechanism, comprising:
a connecting panel, having a first position and a second position;
a mounting base, comprising a base body and two protruding portions, one of the two protruding portions extending along one of both sides of the base body, and the other of the two protruding portions extending along the other of both sides of the base body, wherein the base body defines a notch, the notch is defined between the two protruding portions, each of the two protruding portions define an accommodation slot, and the accommodation slot is opened toward an outer side of the base body; when the connecting panel is arranged in the first position, a portion of the connecting panel is arranged on an inner side of the base body; and when the connecting panel is arranged in the second position, the portion of the connecting panel is arranged in the notch and closes the notch; and
a rotating shaft, extending through the connecting panel and the base body and further extending into the accommodation slot to enable the connecting panel to be switched between the first position and the second position.

2. The rotating mechanism according to claim 1, wherein:
the base body comprises a supporting bar and two connecting bars, the supporting bar extends in an axial direction of the rotating shaft, one of the two connecting bars is connected to one of two opposite ends of the supporting bar, and the other of the two connecting bars is connected to the other of the two opposite ends of the supporting bar; wherein the supporting bar and the two connecting bars cooperatively define the notch, each of the two protruding portions is connected to a corresponding one of the two connecting bars, and the rotating shaft extends through the connecting bars and further extends into the accommodation slot; and
the connecting panel comprises a first panel body and a second panel body, the first panel body comprises an intermediate portion and an outer-edge portion, the outer-edge portion is arranged at a periphery of the intermediate portion, and the outer-edge portion defines an avoidance slot on each of both opposite sides along the axial direction of the rotating shaft; when the connecting panel is arranged in the second position, a portion of each of the two connecting bars is arranged in the avoidance slot, the outer-edge portion, the supporting bar, and the two connecting bars are enclosed together to define a ring structure, and the intermediate portion is arranged in the ring structure; the second panel body is connected to an inner end face of the first panel body, the second panel body defines a second shaft hole arranged along the axial direction of the rotating shaft, and the rotating shaft penetrates into the second shaft hole.

3. A housing case, comprising:
a case cover, comprising a cover shell and a connecting panel connected to the cover shell;
a case body, comprising a shell body and a mounting base, wherein the shell body defines a holding space having a top opening and a first notch defined in a side wall of the shell body, and the holding space is fluidly connected to the first notch; the mounting base comprises a base body and two protruding portions, one of the two protruding portions extends along one of both sides of the base body, and the other of the two protruding portions extends along the other of both sides of the base body; the base body defines a second notch, each of the two protruding portions defines an accommodation slot, the mounting base is mounted in the first notch, the two protruding portions are arranged in the holding space, the accommodation slot is opened towards the side wall of the shell body, and the accommodation slot and the side wall of the shell body cooperatively define a first shaft hole; and
a rotating shaft, extending through the connecting panel and the base body and further extending into the first shaft hole to enable the cover shell to be switched between an open position and a closed position at which the shell body is closed; when the cover shell is in the closed position, a portion of the connecting panel is arranged in the second notch to close the second notch, and a portion of the base body and the portion of the connecting panel cooperatively close the first notch.

4. The housing case according to claim 3, wherein the mounting base comprises:
a supporting bar, extending in an axial direction of the rotating shaft, wherein the supporting bar comprises a step surface formed on an end face of the supporting bar facing towards an outer side of the shell body, and the step surface is supported on a bottom wall of the first notch; and
two connecting bars, wherein one of the two connecting bars is connected to one of two opposite ends of the supporting bar, the other of the two connecting bars is connected to the other of the two opposite ends of the supporting bar, and the supporting bar and the two connecting bars cooperatively define the second notch;
wherein each of the two protruding portions is connected to a corresponding one of the two connecting bars, the rotating shaft extends through the two connecting bars and into the first shaft hole, and the supporting bar and the two connecting bars are mounted in the first notch.

5. The housing case according to claim 4, wherein the connecting panel comprises:
a first panel body, defining an avoidance slot on each of both opposite sides of the first panel body along the axial direction of the rotating shaft; wherein when the cover shell is in the closed position, a portion of each of the two connecting bars is arranged in the avoidance slot, and the portion of each of the two connecting bars, a portion of the supporting bar, and the first panel body cooperatively enclose the first notch; and
a second panel body, comprising a connecting portion and an extension portion extending from the connecting portion toward the case cover, wherein the connecting portion is connected to a side of the first panel body near the holding space, the extension portion is connected to the cover shell, the connecting portion defines a second shaft hole disposed in the axial direction of the rotating shaft, and the rotating shaft penetrates into the second shaft hole.

6. The housing case according to claim 5, wherein the first panel body comprises an intermediate portion and an outer-edge portion, the outer-edge portion is arranged at a periphery of the intermediate portion, and the avoidance slot is defined in the outer-edge portion; the outer-edge portion, the supporting bar, and the two connecting bars are enclosed together to form a ring structure, and the intermediate portion is arranged in the ring structure.

7. The housing case according to claim 5, wherein the first panel body defines a groove on an end face facing toward the holding space, the groove extends in the axial direction of the rotating shaft, and a portion of the rotating shaft is arranged in the groove.

8. The housing case according to claim 5, wherein the second panel body comprises a tab extending from the connecting portion toward the base body, the base body comprises a top panel connected to a top of each of the two connecting bars, and the supporting bar and the top panel cooperatively define a rotating space; and
the rotating shaft is arranged between the top panel and the supporting bar along a height direction of the base body, the tab is capable of rotating around an axis of the rotating shaft within the rotating space, capable of abutting against the top panel to limit the open position of the cover shell, and capable of abutting against the supporting bar to limit the closed position of the cover shell.

9. The housing case according to claim 8, wherein at least one of the connecting portion and the tab has a dimension along the axial direction of the rotating shaft less than a dimension of the first panel body along the axial direction of the rotating shaft.

10. The housing case according to claim 8, wherein the top panel defines an opening slot opened towards the connecting portion; when the cover shell is in the closed position, a portion of the connecting portion is arranged within the opening slot.

11. The housing case according to claim 3, wherein when the cover shell is in the closed position, an outer surface of the shell body, a surface of the base body arranged in the first notch, and a surface of the connecting panel cooperatively form a smooth surface.

12. The housing case according to claim 3, wherein the housing case comprises a elastic member, the cover shell has a critical position arranged between the closed position and the open position, and the elastic member is loaded between the mounting base and the connecting panel; when the cover shell is arranged in the critical position, a torque exerted by the elastic member on the case cover is zero; and when the cover shell deviates to either side of the critical position along a direction of rotation, the elastic member exerts a driving torque on the case cover to drive the cover shell to move to the closed position or the open position.

13. The housing case according to claim 12, wherein the elastic member comprises one or more torsion springs, and each of the one or more torsion springs comprises a first leg, a second leg, and a spiral body; the first leg and the second leg are connected to opposite sides of the spiral body in an axial direction, the first leg is connected to the base body, the second leg is connected to the connecting panel to drive the cover shell to rotate around an axis of the rotating shaft, and an angle between an axis of the spiral body and the axis of rotating shaft is in a range from 45° to 90°.

14. The housing case according to claim 13, wherein the one or more torsion springs comprises two torsion springs, an end of the first leg of one of the two torsion springs is fixedly connected to an end of the first leg of the other of the two torsion springs, and the axis of the spiral body of one of the two torsion springs is substantially parallel to the axis of the spiral body of the other of the two torsion springs.

15. The housing case according to claim 14, wherein the connecting panel defines insertion holes on both opposite sides of the connecting panel along an axial direction of the rotating shaft, an end of the second leg of one of the two torsion springs is arranged in one of the insertion holes, and an end of the second leg of the other of the two torsion springs is arranged in the other of the insertion holes.

16. The housing case according to any claim 3, wherein the shell body defines an insertion slot on an inner surface of the housing case, the base body is capable of being inserted into the insertion slot from the top opening of the holding space, and the base body is supported on a bottom wall of the insertion slot.

17. The housing case according to claim 16, wherein the case body comprises a first protrusion bar and two second protrusion bars, the first protrusion bar and the two second protrusion bars protrude from the inner surface of the shell body, the first protrusion bar extends in a direction substantially parallel to an axial direction of the rotating shaft, and each of the two second protrusion bars extends from a corresponding one of two opposite ends of the first protrusion bar toward the case cover; an end of one of the two second protrusion bars away from the shell body is bent toward a side of the other of the two second protrusion bars, the two second protrusion bars, the first protrusion bar, and the inner surface of the shell body cooperatively define the insertion slot, and the base body is supported on the first protrusion bar.

18. The housing case according to claim 16, wherein the housing case comprises a storage panel abutting against a side of the base body facing the case cover, and the base body is fixed in the insertion slot via the storage panel.

19. The housing case according to claim 3, wherein the housing case is an earphone charging box, earphones are stored in the holding space, and the earphone charging box is capable of charging the earphones.

20. A housing case, comprising:
a case, defining a first notch in a side wall of the case;
a cover, connected to the case and having an open position at which the case is opened and a closed position at which the case is closed;
a mounting base, mounted in the first notch, and comprising:
a supporting bar; and
two connecting bars, wherein one of the two connecting bars is connected to one of two opposite ends of the supporting bar, the other of the two connecting bars is connected to the other of the two opposite ends of the supporting bar, and the supporting bar and the two connecting bars cooperatively define a second notch;
a connecting panel, connected to the cover and comprising:
an intermediate portion; and
an outer-edge portion, arranged at a periphery of the intermediate portion; and
a rotating shaft, extending through the connecting panel and connected to the case to enable the cover to be switched between the open position and the closed position;
wherein when the cover is in the closed position, the outer-edge portion, the supporting bar, and the two connecting bars are enclosed together to define a ring structure, and the intermediate portion is arranged in the ring structure, such that the supporting bar, the two connecting bars, the outer-edge portion and the intermediate portion cooperatively close the first notch, while the outer-edge portion and the intermediate portion cooperatively close the second notch.
